(19) United States
(12) Patent Application Publication
(10) Pub. No.: US 2016/0005121 A1
(43) Pub. Date: Jan. 7, 2016

(54) SYSTEMS AND METHODS FOR PROVIDING EXCHANGE TRADED FUNDS AS AN INVESTMENT OPTION FOR INDIVIDUAL ACCOUNT RETIREMENT PLANS

(71) Applicant: John Hancock Life Insurance Company (U.S.A), Boston, MA (US)

(72) Inventor: Roy Kapoor, Toronto (CA)

(21) Appl. No.: 14/789,353

(22) Filed: Jul. 1, 2015

Related U.S. Application Data
(60) Provisional application No. 62/019,521, filed on Jul. 1, 2014.

(51) Int. Cl. G06Q 40/04; G06Q 40/06

(52) U.S. Cl. CPC G06Q 40/04; G06Q 40/06

(57) ABSTRACT

The disclosed technology relates generally to a method and system for providing exchange traded funds (ETFs) as investment options for individual account retirement plans. Participants may purchase, in certain embodiments, ETFs, mutual funds, collective investment trusts or other investments for their retirement plan accounts. The disclosed technology provides participants with the ability to purchase ETFs for their retirement account and benefit from these advantages. The disclosed technology enables participants to be allocated fractional shares—thus allowing them to purchase and sell a desired number of shares without having to round their purchase to the nearest whole share. Instead, a house account is used to purchase or sell the number of shares necessary to execute a whole share transaction. This provides participants with increased flexibility from low investment costs and broad investment choices—gaining the ability to more precisely tailor their retirement investments and save more for retirement.

### PRIORITY APPLICATION

This application claims priority to and the benefit of U.S. Provisional Patent Application No. 62/019,521, filed Jul. 1, 2014, titled “Systems and Methods for Providing Exchange Traded Funds as an Investment Option for Individual Account Retirement Plans,” the contents of which are incorporated by reference herein in its entirety.

### BACKGROUND OF THE INVENTION

Traditionally, 401(k) plans invest in mutual funds. In contrast to some mutual funds which are actively-managed, exchange traded funds (ETFs) typically track an index, commodity, or a basket of assets. The passive nature of ETFs reduces their expenses relative to actively-managed mutual funds; thus, it may be desirable to hold ETFs in a retirement account.

ETFs are bought and sold on an exchange and, in contrast to mutual funds, transactions involving ETFs must be completed in whole shares. This distinction is important in the context of retirement accounts as many individuals purchase shares in a retirement plan based on a percentage of income. Thus, the investment amount rarely equals the amount needed to purchase a whole number of ETF shares. In order to facilitate the use of ETFs in 401k plans, a recordkeeping system must be able to allocate fractional shares of ETFs.

### SUMMARY OF THE INVENTION

The disclosed technology relates generally to a method and system for providing exchange traded funds (ETFs) as investment options for retirement account plans. Participants may purchase, in certain embodiments, either ETFs or mutual funds for their retirement plan accounts. This provides participants with increased flexibility when investing their retirement savings. Participants benefit from low investment costs and broad investment choices—gaining the ability to more precisely tailor their retirement investments and save more for retirement. The disclosed technology provides participants with the ability to purchase ETFs for their retirement account and benefit from these advantages.

While whole-share purchases are not required for participants, ETF share transactions must be executed on the market as whole-share transactions. The disclosed technology enables participants to be allocated fractional shares—thus allowing them to purchase and sell a desired number of shares without having to round their purchase to the nearest whole share. Instead, a house account is used to purchase or sell the number of shares necessary to execute a whole share transaction. ETF share purchases within and across plans may be aggregated within a given time window prior to executing a transaction. The house account will be used to purchase the additional shares necessary to send a whole share order to the market. Similarly, ETF share sale transactions will also be aggregated within and across plans for a given time window. The house account will be used to provide additional shares necessary to ensure that a whole share transaction is sent to be executed.

For example, if a retirement plan participant wants to invest $100 in an ETF that is trading at $60/share, and this is the only participant that wishes to purchase shares of this ETF during a given time period, the disclosed technology will execute a trade for 2 shares of the ETF. The participant will be allocated 1 full share and a 2/3 fractional share (i.e., the number of shares that correlate to a $100 investment). The house account will be used to fund the purchase of the additional ⅓ of a share necessary to send a whole number transaction to the market (i.e., 2 shares in this example) and the house account will be allocated ⅓ of a share of the ETF.

The disclosed technology, in certain embodiments, includes receiving, by a processor of a computing device, for each of a plurality of retirement plan accounts, a request to purchase shares of an exchange traded fund (ETF). Each retirement plan account of the plurality of retirement plan accounts is associated with one of a plurality of retirement plans serviced by an entity and each of the plurality of requests are made during a specified time period. Each of the plurality of requests may also identify an amount of money or a number of shares to invest in the ETF.

The method may include determining, by the processor, a sum of money to invest in the ETF based at least in part on the plurality of requests; determining, by the processor, a first number of shares of the ETF to purchase for the plurality of retirement plan accounts to satisfy the plurality of requests based at least in part on the sum of money and a market price, wherein the first number of shares is not a whole number; determining, by the processor, a total whole number of shares of the ETF to purchase by rounding the first number of shares up to a nearest whole number of shares, wherein a house account associated with the entity is used to provide funds so that a whole number of shares is purchased with the sum of money and funds from the house account, thereby allowing at least one of the retirement plan accounts to be allocated a fractional share; and sending, by the processor, an order to purchase the total whole number of shares of the ETF.

In certain embodiments, the entity funds the house account. The sum of money to invest in the ETF may be the sum of money the plurality of requests identified to be invested in the ETF during the specified time period. Determining the sum of money to invest in the ET, includes, in certain embodiments, aggregating, by the processor, the amount of money to invest in the ETF for each of the plurality of retirement plans; and aggregating, by the processor, the amount of money to invest in the ETF for all of the plurality of retirement plans.

The market price may be determined based on a third party price feed at a time before an end of the specified time period. The specified time period may be one of a plurality of time periods during market hours. For example, the specified time period may be 9:30 a.m.-10:00 a.m. ET; 10:00 a.m.-11:00 a.m. ET; 11:00 a.m.-12:00 p.m. ET; 12:00 p.m.-1:00 p.m. ET; 1:00 p.m.-2:00 p.m. ET; 2:00 p.m.-3:00 p.m. ET; and/or 3:00 p.m.-3:30 p.m. ET.

The disclosed technology, in certain embodiments, includes receiving, by a processor of a computing device, for each of a plurality of retirement plan accounts, a request to sell shares of an exchange traded fund (ETF). Each retirement plan account of the plurality of retirement plan accounts may be associated with one of a plurality of retirement plans serviced by an entity, each of the plurality of requests may be made during a specified time period, and each of the plurality of requests may identify at least one of an amount of money, a percentage of a holding, and a number of shares to sell of the ETF.

The method may include determining, by the processor, a sum of money to sell of the ETF based at least in part on the plurality of requests; determining, by the processor, a first number of shares of the ETF to sell for the plurality of retirement plan accounts to satisfy the plurality of requests based at least in part on the sum of money and a market price, wherein the first number of shares is not a whole number; determining, by the processor, a total whole number of shares of the ETF to sell by rounding the first number of shares up to a nearest whole number of shares, wherein a house account associated with the entity is used to provide a fractional ETF share such that a whole number of shares is sold with the sum of money and shares from the house account, thereby allowing at least one of the retirement plan accounts to transact in fractional shares; and sending, by the processor, an order to sell the total whole number of shares of the ETF.

### BRIEF DESCRIPTION OF THE FIGURES

The foregoing and other objects, aspects, features, and advantages of the present disclosure will become more apparent and better understood by referring to the following description taken in conjunction with the accompanying drawings, in which:

FIG. 1 is an illustration of an example ETF order trading process;

FIGS. 2A-B are diagrams of the potential impact of share price changes on purchase and sale transactions using the disclosed technology;

FIG. 3 is an illustration of an example method for purchasing shares of an ETF for a retirement plan account;

FIG. 4 is an illustration of an example method 400 for selling shares of an ETF for a retirement plan account;

FIG. 5 shows a block diagram of an exemplary cloud computing environment; and

FIG. 6 is a block diagram of a computing device and a mobile computing device.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION OF THE INVENTION

The disclosed technology, in some implementations, provides a system and/or method of providing retirement plans a way to invest in exchange traded funds (ETFs). The system enables plan participants to invest retirement funds in exchange traded funds and/or other funds such as mutual funds. All plan ETF purchase and sale transactions take place over an exchange. These transactions may be executed by an unaffiliated broker-dealer and must be completed in whole shares.

While ETFs only trade in whole shares, the disclosed technology enables plan participants to transact in whole and fractional shares (e.g., plan participants may be allocated both whole and fractional shares). The allocation of fractional shares enables plan participants to purchase ETFs even when the investment amount is not sufficient to purchase whole multiples of ETF shares.

While whole-share purchases are not required for participants, ETF share transactions must be executed on the market as whole-share transactions. ETF share purchases within and across plans for which the same entity serves as the administrator or record keeper may be aggregated prior to executing a transaction. Similarly, ETF share sale transactions will also be aggregated within and across plans. In some implementations, the aggregation occurs with respect to transactions requested within the same trade window (e.g., multiple participants may request the purchase of the same ETF during the same designated trade window and all such requests will be aggregated and sent for execution). In some implementations, ETF share purchase and sale transactions are not netted within or across plans—separate purchase and sale orders will be sent to the market. In some implementations, ETF share purchase and sale transactions are netted within or across plan. They system maintains records of transactions by accounts associated with retirement plans, including fractional share recordkeeping for exchange traded funds.

In the event that a purchase or sale transaction for an ETF (i.e., after aggregating within and across plans) does not equate to a whole-share purchase or sale, the purchase or sale transaction may be rounded to the next whole share before transmitting the order for execution. To support the allocation of fractional shares to plan participants, a house account will be used to ‘top up’ participant orders (e.g., purchase and sale orders) to ‘whole’ share increments. The house account may be associated with the entity that provides recordkeeping services to the retirement plans. For example, the entity that provides recordkeeping services to the retirement plans may fund the house account.

The house account will be used to fund the remainder of the ETF share price needed to purchase a “rounded up” whole share. The house account will hold an inventory of ETF fractional shares purchased by the house account. Similarly, shares of an ETF purchased using the house account will be used to supply the remainder of an ETF share in a “rounded up” whole share sale transaction. The proceeds received from a sale transaction involving shares owned by the house account will be returned to the house account. Initially, in some implementations, the house account may be pre-configured to hold a range of ETF inventory with respect to the number of shares held (e g, minimum number of shares=3 shares per ETF, target number of shares=5 shares per ETF, maximum number of shares=7 shares per ETF). These variables (e.g., minimum, target, and maximum number of shares per ETF) may be configurable.

In some implementations, the first time an ETF is purchased by any participant, the house account will automatically buy a certain number of shares (e.g., 5 shares) of that ETF. When the house account balance falls below a threshold number of shares (e.g., 3 shares) of a particular ETF, the system may, in the next trading window, buy as many shares as are required to bring the house account holdings up to the target (e.g., 5 shares) of that ETF. When the house account balance exceeds a threshold number of shares (e.g., 7 shares) of a particular ETF, the system may, in the next trading window, sell as many shares as are required to bring the house account holdings down to the target (e.g., 5 shares) of that ETF. When the house account has the only remaining position in a particular ETF and there are no retirement plans with this particular ETF in a fund line up, the recordkeeping system may automatically sell all shares of this ETF.

Participants may request to buy or sell a specific number of shares. In addition, participants may also request that a specific dollar amount (such as the amount of the participant's elective deferral to the 401(k) plan) be used to buy as many ETF shares as possible, and participants may request to sell a specific dollar amount worth of ETF share holdings. Dollar-specific buy and sell orders must be translated to a number of shares to purchase on the exchange. This determination is made by estimating the number of shares that must be purchased or sold based on price feeds supplied by a third party.

In some implementations, the system will place a purchase order for a number of shares of a particular ETF at the close of a particular trading window equal to (i) the number of shares of the ETF requested by participants (in all plans for which the same entity serves as the administrator or record keeper) who requested the purchase of a specific number of ETF shares, and (ii) the number of shares of the ETF equal to (A) the aggregate amount of money from all participants who requested the purchase of the ETF using a specific dollar amount of money (or percentage of a contribution), divided by (B) the estimated price of the ETF per share (using the third party price feed). The system will round the resulting number of ETF shares up to the next whole share before transmitting the purchase order for execution, using assets from the house account to fund the purchase of any fraction of an ETF share. The system will place a sell order for a number of shares of a particular ETF at the close of a particular trading window equal to (i) the number of shares of the ETF requested by participants (in all plans for which the same entity serves as the administrator or record keeper) who requested the sale of a specific number of ETF shares, and (ii) the number of shares of the ETF equal to (A) the aggregate value of ETF shares from all participants who requested the sale of a specific dollar amount of ETF shares, divided by (B) the estimated price of the ETF per share (using the third party price feed). The system will round the resulting number of ETF shares up to the next whole share before transmitting the sale order for execution, using ETF shares from the house account to complete the sale of any fraction of an ETF share.

However, the actual purchase or sale price when the trade is executed may be different from the estimated trade price. Five scenarios are possible: the order fill price may be the same as the estimated price, the order fill price may be slightly greater or less than the estimated price, and the order fill price may be much greater or less than the estimated price. When the order fill price is the same as the estimated price, the order will be executed as planned. Similarly, when the order fill price is slightly greater or less than the estimated price, the order will not be impacted. The participant will receive slightly fewer or more shares than were originally estimated, respectively, and the balance (less than one full share) will go to the house account.

If the order price is much greater than the estimated price, the estimated share order will be greater than the actual shares purchase and the system has effectively over ordered. The participants will receive fewer shares than were originally estimated. The house account again receives the balance which will be more than one full share.

Finally, when the order fill price is much lower than the estimated price, the estimated share order will be less than the actual shares purchased and the system has effectively under ordered. In such case, the system generates an immediate order to purchase more shares. The house account will again be allocated any remaining balance of the shares acquired. Similar scenarios play out for ETF share sales. Specifically, the only instance in which an additional sell order is placed is when the order fill price is much lower than the estimated price.

While ETF trading occurs in the market continuously during trading hours, requests for plan ETF trading are aggregated for execution following the close of designated trading windows. Specifically, trade requests made during a trading window will be aggregated during that trading window and executed instantaneously upon the close of that trading window. Trade requests made during the next trading window will be aggregated and executed instantaneously upon the close of that trading window. For example, there may be eight hourly trading windows each trading day for ETF trading. In some implementations, no trades may be submitted after the close of the applicable exchange. In some implementations, trades submitted after the close of the applicable exchange will be aggregated and executed instantaneously upon the close of the first trading window on the next day the market is open. For example, in some implementations, the designated trading windows are 9:30 a.m.-10:00 a.m. ET; 10:00 a.m.-11:00 a.m. ET; 11:00 a.m.-12:00 p.m. ET; 12:00 p.m.-1:00 p.m. ET; 1:00 p.m.-2:00 p.m. ET; 2:00 p.m.-3:00 p.m. ET; and 3:00 p.m.-3:30 p.m. ET.” In some implementations, the trading windows can be configured. Additional windows (e.g., 9:30 AM (EST) and 3:45 PM (EST)) may be provided to facilitate market opening and closing times.

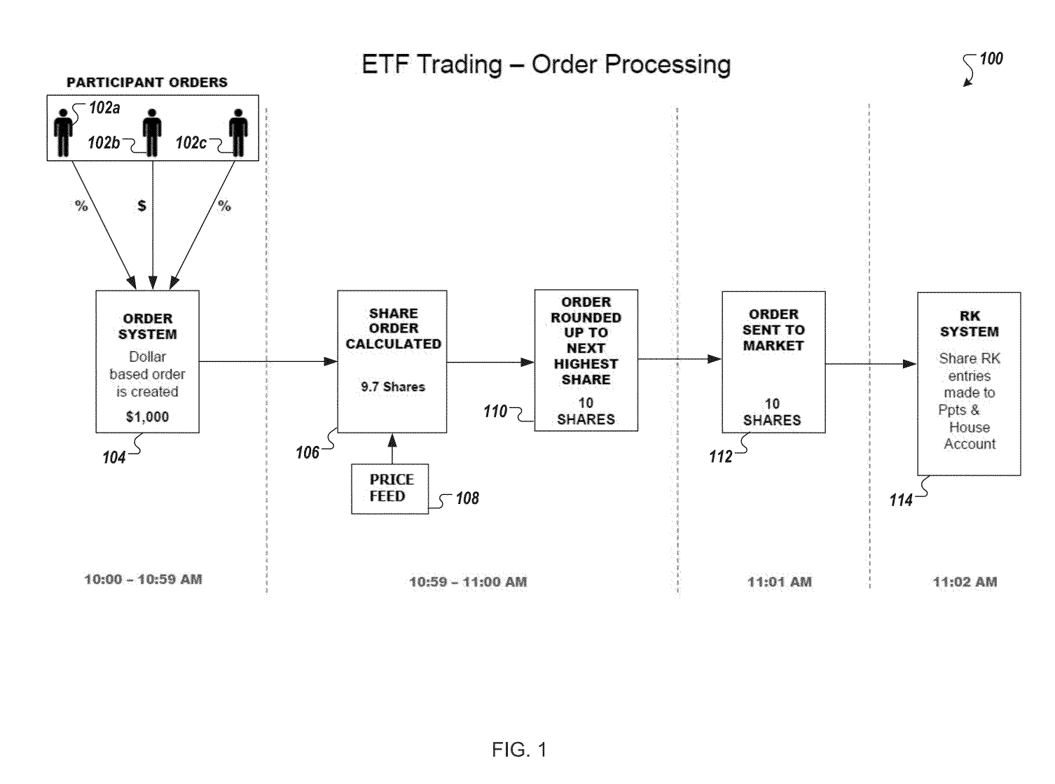

FIG. 1 is an illustration of an example ETF order trading process 100. Retirement plan participants 102a-c (collectively, 102) may wish to hold shares of an ETF in their retirement plan accounts. Participants 102 may specify their orders in terms of a number of shares, an amount of money, or a percentage of certain trades (e.g., a percentage of paycheck or other payment). An order system 104 receives the order and a dollar based order is created. The dollar based order represents the aggregation of all of the participant orders for an ETF during a specified time period, as explained above. In this example, the time period is from 10:00 am to 10:59 am. Participants' orders may be aggregated with other orders for the same ETF within a plan. After aggregating within a plan, the orders for the same ETF may be aggregated across plans for which the same entity serves as recordkeeper. A separate dollar based order is created by the order system 104 for each ETF for which an order is received during a given time period.

The share order is calculated after the given time period has closed 106 based on the dollar based order and a price feed 108. The price feed 108 provides the estimated market price of a share of an ETF. The estimated market price is used to determine the number of shares of an ETF that may be purchased with the money aggregated for purchasing shares of that ETF.

After calculating the share order 106, the order is rounded up to the next highest share 110. As explained above, ETF transactions must be based in whole numbers of shares. Thus, the order sent to the market 112 is the share order rounded up to the next highest share. A house account is used to provide funds in order to send a whole number share order to the market. After the order is executed on the market, the record keeping system 114 attributes the appropriate amount of shares to each participant 102 and to the house account 114. Even though ETF transactions must be based in whole numbers of shares, the disclosed technology enables participants to be allocated a fractional share. This provides participants with increased flexibility and convenience when transacting in ETFs for a retirement account.

In the example shown in FIG. 1, the dollar based order is $1000 for an ETF. The system determines that 9.7 shares of the ETF may be purchased for $1000 based on the market price from the price feed 108 (the market price from the price feed 108 may be a real-time market price or a delayed market price). The order is rounded to 10 shares and sent to market. In this example, the house account would fund the purchase of 0.3 shares. The 9.7 shares would be allocated among the participants based on the amount each participant invested in the ETF. As shown in FIG. 1, this process may take place over the course of a few minutes. In some implementations, the process is executed as quickly as possible. This helps ensure the share price from the price feed 108 (which is used to determine the share order 106) is as close as possible to the share price when the trades are executed on the market. In some implementations, the share price when the trades are executed may be different than the share price from the price feed 108 (e.g., the share price may increase or decrease because of market factors/conditions). This may impact the number of shares purchased overall or the allocation of shares to participants and the house account.

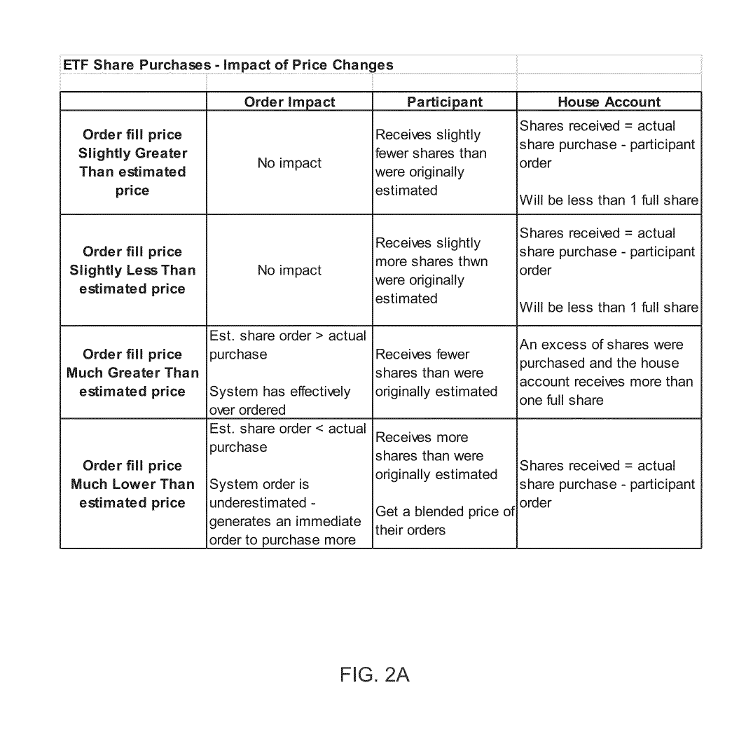

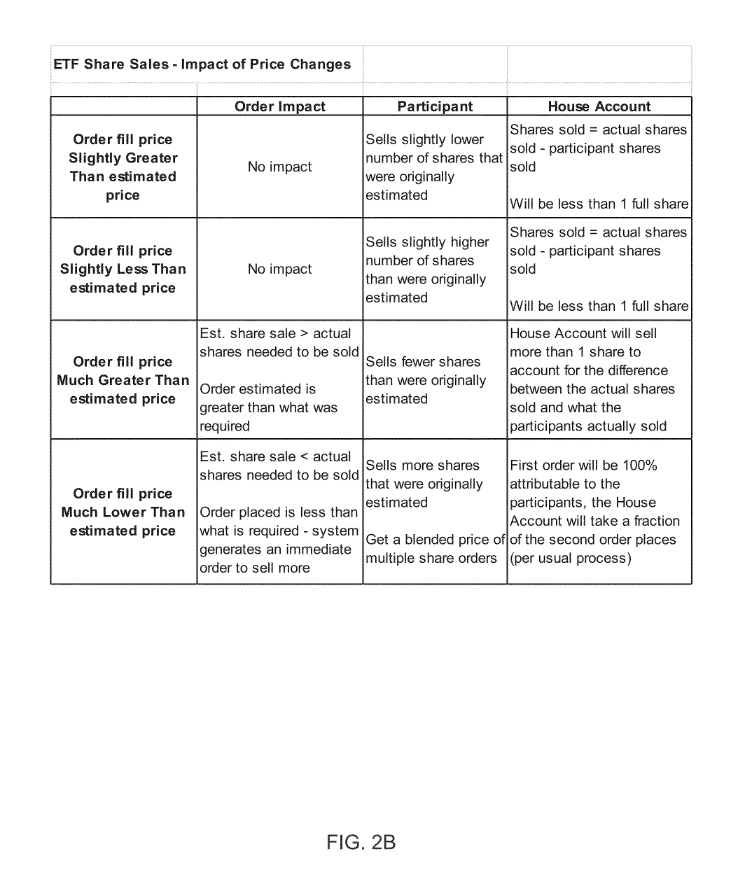

FIGS. 2A-B are diagrams of the potential impact of share price changes on purchase and sale transactions using the disclosed technology (e.g., differences between the price from the price feed and the actual transaction share price). FIG. 2A illustrates the impact of share price changes on a purchase transaction using the disclosed technology. If the order fill price is slightly greater than the estimated price (e.g., the price from the price feed), the order will not be impacted. The participants will receive slightly fewer shares than were originally estimated. The house account will receive the difference between the actual shares purchased and the number of shares allocated to the participants (less than 1 full share).

If the order fill price is slightly less than the estimated price, the order will not be impacted. The participants will receive slightly more shares than were originally estimated. The house account will receive the difference between the actual shares purchased and the number of shares allocated to the participants (less than 1 full share).

If the order fill price is much greater than the estimated price, the estimated share order is greater than the actual shares purchased—the system has effectively over ordered. The participant will receive fewer shares than were originally estimated. The house account will receive more shares than estimated since an excess of shares was purchased.

If the order fill price is much lower than the estimated price, the estimated share order will be less than the actual shares purchased. The order is under-estimated and an immediate order to purchase more shares is generated and sent to be executed. The participant will receive more shares than were originally estimated and will get the blended price of their orders. The house account will be allocated the difference between the actual shares purchased and the number of shares allocated to the participants.

FIG. 2B illustrates the impact of share price changes on a sale transaction using the disclosed technology. If the order fill price is slightly greater than the estimated price (e.g., the price from the price feed), the order will not be impacted. The participants will sell slightly fewer shares than were originally estimated. The house account will sell the difference between the actual shares sold and the number of participant shares sold (less than 1 full share).

If the order fill price is slightly less than the estimated price, the order will not be impacted. The participants will sell slightly more shares than were originally estimated. The house account will sell the difference between the actual shares sold and the number of participant shares sold (less than 1 full share).

If the order fill price is much greater than the estimated price, the estimated shares sold is greater than the actual shares needed to be sold—the order estimated is greater than what was required. The participant will sell fewer shares than were originally estimated. The house account will sell more than one share to account for the difference between the actual shares sold and what the participants actually sold.

If the order fill price is much lower than the estimated price, the estimated share sale will be less than the actual shares needed to be sold. The order is under-estimated and an immediate order to sell more shares is generated and sent to be executed. The participant will sell more shares than were originally estimated and will get the blended price of their orders. The first order will be 100% attributable to the participants (i.e., because it was underestimated). A fraction of a share will be debited from the house account when the second order takes place.

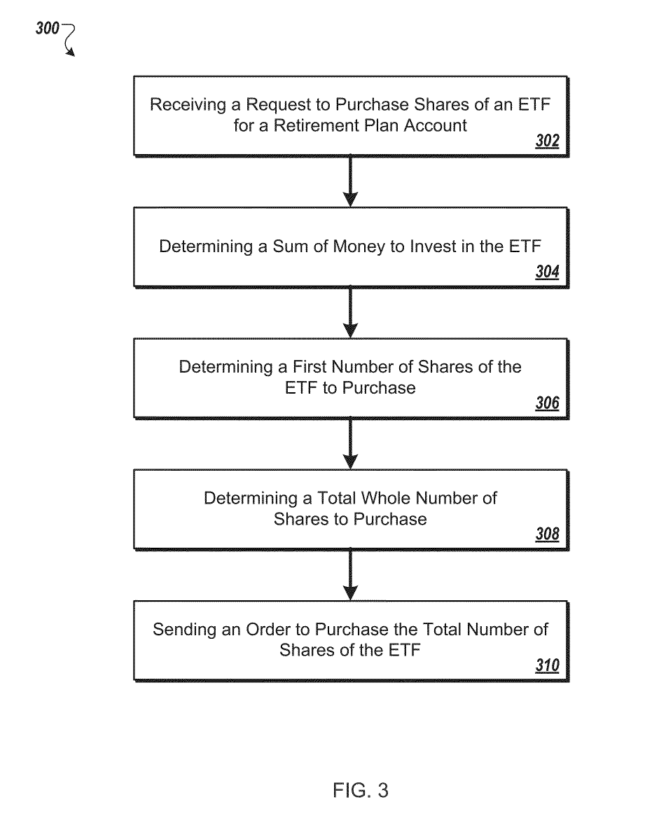

FIG. 3 is an illustration of an example method 300 for purchasing shares of an ETF for a retirement plan account. In some implementations, the method 300 includes receiving, for each of a plurality of retirement plan accounts, a request to purchase shares of an ETF (302). Each retirement plan account of the plurality of retirement plan accounts is associated with one of a plurality of retirement plans serviced by an entity. As explained above, each of the plurality of requests are made during a specified time period and identify an amount of money or a number of shares to invest in the ETF.

A sum of money to invest in the ETF may be determined based at least in part on the plurality of requests (304). In some implementations, the sum of money is determined by (i) aggregating the amount of money to invest in the ETF for each of the plurality of retirement plans and (ii) aggregating the amount of money to invest in the ETF for all of the plurality of retirement plans. The sum of money to invest in the ETF may be the sum of money the plurality of requests identified to be invested in the ETF during the specified time period.

The method may include determining a first number of shares of the ETF to purchase for the plurality of retirement plan accounts to satisfy the plurality of requests based at least in part on the sum of money and a market price (306). The market price may be determined based on a third party price feed at a time (e.g., before an end of the specified time period or immediately after the end of a specified time period). In some cases, the first number of shares is not a whole number (e.g., a fractional share may be purchased for a retirement plan account). A total whole number of shares of the ETF to purchase is determined by rounding the first number of shares up to a nearest whole number of shares (308). A house account (e.g., associated with and/or funded by the entity that serves as recordkeeper for the retirement plans) is used to provide funds so that a whole number of shares is purchased with the sum of money and funds from the house account. This allows at least one of the retirement plan accounts to be allocated fractional shares. This also allows the desired amount to be purchased for each of the retirement plan accounts—the amount the retirement plan participant wishes to purchase will not be rounded down. After determining the total whole number of shares to purchase, an order to purchase the total whole number of shares of the ETF may be transmitted to a broker to be executed (310).

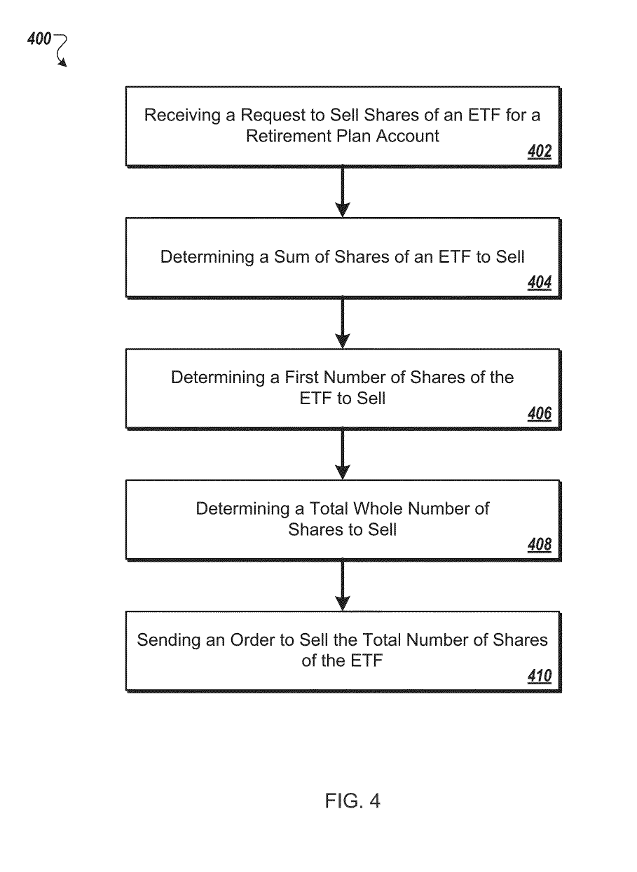

FIG. 4 is an illustration of an example method 400 for selling shares of an ETF for a retirement plan account. In some implementations, the method 400 includes receiving, for each of a plurality of retirement plan accounts, a request to sell shares of an ETF (402). Each retirement plan account of the plurality of retirement plan accounts is associated with one of a plurality of retirement plans serviced by an entity. As explained above, each of the plurality of requests are made during a specified time period and identify an amount of money or a number of shares to sell in the ETF.

A sum of money to sell of the ETF may be determined based at least in part on the plurality of requests (404). In some implementations, the sum of money is determined by (i) aggregating the amount of money to sell of the ETF for each of the plurality of retirement plans and (ii) aggregating the amount of money to sell of the ETF for all of the plurality of retirement plans. The sum of money to sell of the ETF may be the sum of money the plurality of requests identified to be sold in the ETF during the specified time period. The sum of money may be number of shares, a percentage of a holding, and/or an amount of money.

The method may include determining a first number of shares of the ETF to sell for the plurality of retirement plan accounts to satisfy the plurality of requests based at least in part on the sum of money and a market price (406). The market price may be determined based on a third party price feed at a time (e.g., before an end of the specified time period or immediately after the end of a specified time period). In some cases, the first number of shares is not a whole number (e.g., a fractional share may be purchased for a retirement plan account). A total whole number of shares of the ETF to sell is determined by rounding the first number of shares up to a nearest whole number of shares (408). A house account (e.g., associated with and/or funded by the entity that serves as recordkeeper for the retirement plans) is used to provide a fractional ETF share such that a whole number of shares is sold with the sum of money and shares from the house account. This allows at least one of the retirement plan accounts to be allocated fractional shares. This also allows the desired amount to be sold for each of the retirement plan accounts. After determining the total whole number of shares to sell, an order to sell the total whole number of shares of the ETF may be transmitted to a broker to be executed (410).

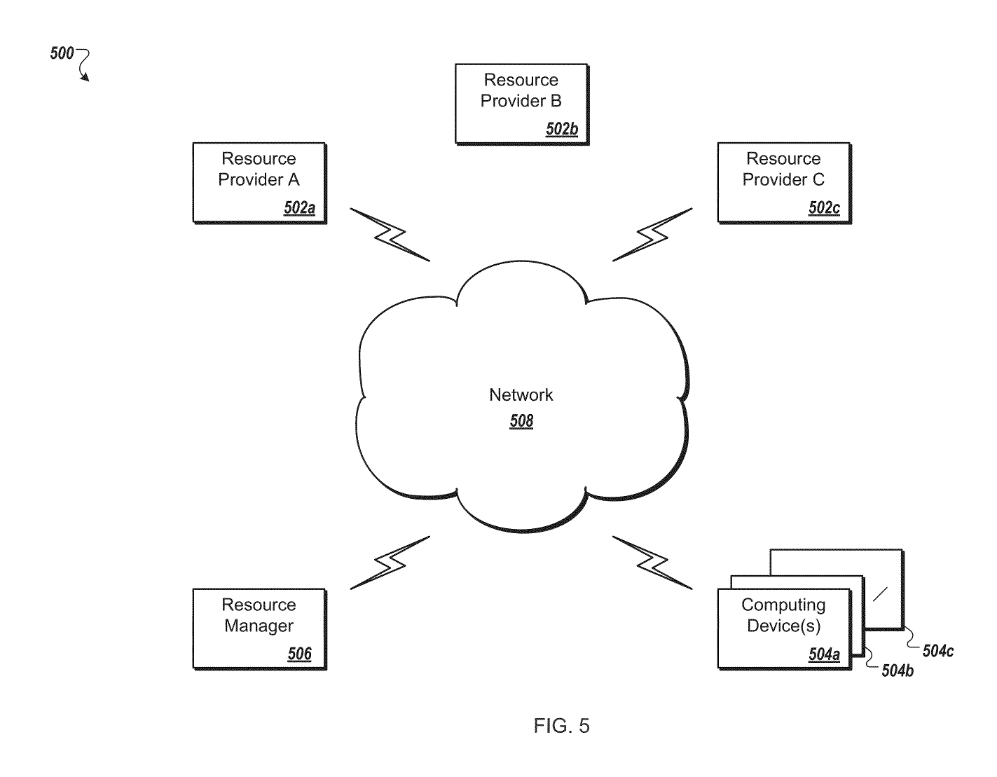

As shown in FIG. 5, an implementation of a network environment 500 for use in providing ETFs for retirement accounts plans is shown and described. In brief overview, referring now to FIG. 5, a block diagram of an exemplary cloud computing environment 500 is shown and described. The cloud computing environment 500 may include one or more resource providers 502a, 502b, 502c (collectively, 502). Each resource provider 502 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 502 may be connected to any other resource provider 502 in the cloud computing environment 500. In some implementations, the resource providers 502 may be connected over a computer network 508. Each resource provider 502 may be connected to one or more computing device 504a, 504b, 504c (collectively, 504), over the computer network 508.

The cloud computing environment 500 may include a resource manager 506. The resource manager 506 may be connected to the resource providers 502 and the computing devices 504 over the computer network 508. In some implementations, the resource manager 506 may facilitate the provision of computing resources by one or more resource providers 502 to one or more computing devices 504. The resource manager 506 may receive a request for a computing resource from a particular computing device 504. The resource manager 506 may identify one or more resource providers 502 capable of providing the computing resource requested by the computing device 504. The resource manager 506 may select a resource provider 502 to provide the computing resource. The resource manager 506 may facilitate a connection between the resource provider 502 and a particular computing device 504. In some implementations, the resource manager 506 may establish a connection between a particular resource provider 502 and a particular computing device 504. In some implementations, the resource manager 506 may redirect a particular computing device 504 to a particular resource provider 502 with the requested computing resource.

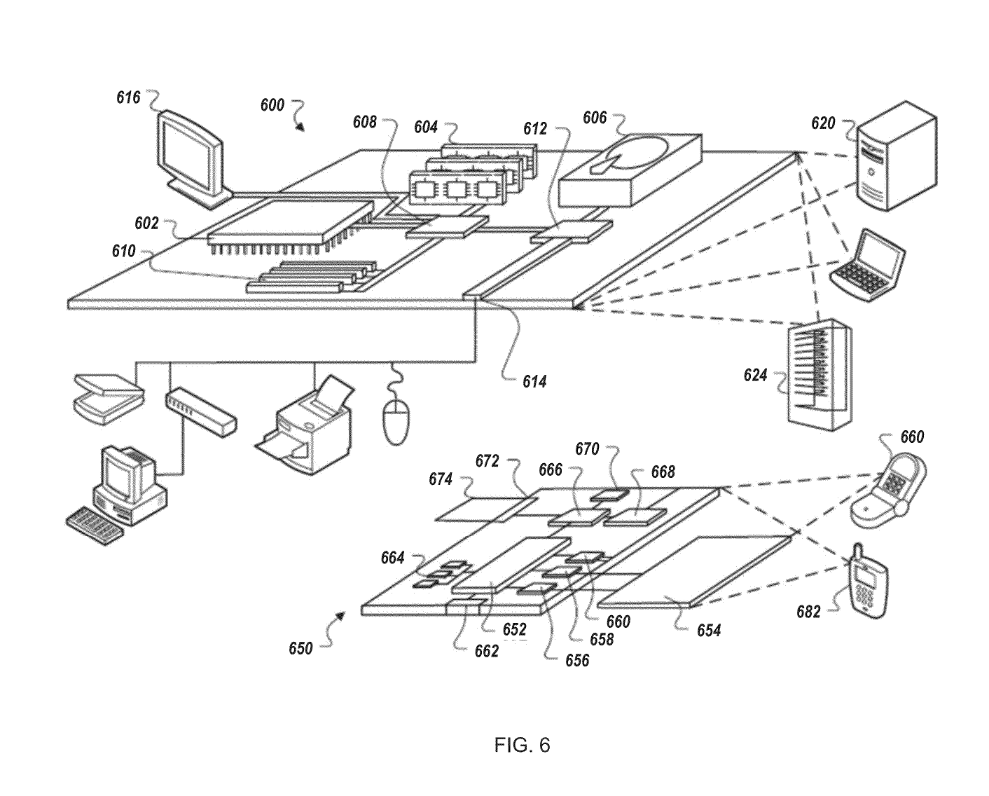

FIG. 6 shows an example of a computing device 600 and a mobile computing device 650 that can be used to implement the techniques described in this disclosure. The computing device 600 is intended to represent various forms of digital computers, such as laptops, desktops, workstations, personal digital assistants, servers, blade servers, mainframes, and other appropriate computers. The mobile computing device 650 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 600 includes a processor 602, a memory 604, a storage device 606, a high-speed interface 608 connecting to the memory 604 and multiple high-speed expansion ports 610, and a low-speed interface 612 connecting to a low-speed expansion port 614 and the storage device 606. Each of the processor 602, the memory 604, the storage device 606, the high-speed interface 608, the high-speed expansion ports 610, and the low-speed interface 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as a display 616 coupled to the high-speed interface 608. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 604 stores information within the computing device 600. In some implementations, the memory 604 is a volatile memory unit or units. In some implementations, the memory 604 is a non-volatile memory unit or units. The memory 604 may also be another form of computer-readable medium, such as a magnetic or optical disk.

The storage device 606 is capable of providing mass storage for the computing device 600. In some implementations, the storage device 606 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 602), perform one or more methods, such as those described above. The instructions can also be stored by one or more storage devices such as computer- or machine-readable mediums (for example, the memory 604, the storage device 606, or memory on the processor 602).

The high-speed interface 608 manages bandwidth-intensive operations for the computing device 600, while the low-speed interface 612 manages lower bandwidth-intensive operations. Such allocation of functions is an example only. In some implementations, the high-speed interface 608 is coupled to the memory 604, the display 616 (e.g., through a graphics processor or accelerator), and to the high-speed expansion ports 610, which may accept various expansion cards (not shown). In the implementation, the low-speed interface 612 is coupled to the storage device 606 and the low-speed expansion port 614. The low-speed expansion port 614, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard server 620, or multiple times in a group of such servers. In addition, it may be implemented in a personal computer such as a laptop computer 622. It may also be implemented as part of a rack server system 624. Alternatively, components from the computing device 600 may be combined with other components in a mobile device (not shown), such as a mobile computing device 650. Each of such devices may contain one or more of the computing device 600 and the mobile computing device 650, and an entire system may be made up of multiple computing devices communicating with each other.

The mobile computing device 650 includes a processor 652, a memory 664, an input/output device such as a display 654, a communication interface 666, and a transceiver 668, among other components. The mobile computing device 650 may also be provided with a storage device, such as a micro-drive or other device, to provide additional storage. Each of the processor 652, the memory 664, the display 654, the communication interface 666, and the transceiver 668, are interconnected using various buses, and several of the components may be mounted on a common motherboard or in other manners as appropriate.

The processor 652 can execute instructions within the mobile computing device 650, including instructions stored in the memory 664. The processor 652 may be implemented as a chipset of chips that include separate and multiple analog and digital processors. The processor 652 may provide, for example, for coordination of the other components of the mobile computing device 650, such as control of user interfaces, applications run by the mobile computing device 650, and wireless communication by the mobile computing device 650.

The processor 652 may communicate with a user through a control interface 658 and a display interface 656 coupled to the display 654. The display 654 may be, for example, a TFT (Thin-Film-Transistor Liquid Crystal Display) display or an OLED (Organic Light Emitting Diode) display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may provide communication with the processor 652, so as to enable near area communication of the mobile computing device 650 with other devices. The external interface 662 may provide, for example, for wired communication in some implementations, or for wireless communication in other implementations, and multiple interfaces may also be used.

The memory 664 stores information within the mobile computing device 650. The memory 664 can be implemented as one or more of a computer-readable medium or media, a volatile memory unit or units, or a non-volatile memory unit or units. An expansion memory 674 may also be provided and connected to the mobile computing device 650 through an expansion interface 672, which may include, for example, a SIMM (Single In Line Memory Module) card interface. The expansion memory 674 may provide extra storage space for the mobile computing device 650, or may also store applications or other information for the mobile computing device 650. Specifically, the expansion memory 674 may include instructions to carry out or supplement the processes described above, and may include secure information also. Thus, for example, the expansion memory 674 may be provided as a security module for the mobile computing device 650, and may be programmed with instructions that permit secure use of the mobile computing device 650. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier and, when executed by one or more processing devices (for example, processor 652), perform one or more methods, such as those described above. The instructions can also be stored by one or more storage devices, such as one or more computer- or machine-readable mediums (for example, the memory 664, the expansion memory 674, or memory on the processor 652). In some implementations, the instructions can be received in a propagated signal, for example, over the transceiver 668 or the external interface 662.

The mobile computing device 650 may communicate wirelessly through the communication interface 666, which may include digital signal processing circuitry where necessary. The communication interface 666 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 668 using a radio-frequency. In addition, short-range communication may occur, such as using a Bluetooth®, Wi-Fi™, or other such transceiver (not shown). In addition, a GPS (Global Positioning System) receiver module 670 may provide additional navigation- and location-related wireless data to the mobile computing device 650, which may be used as appropriate by applications running on the mobile computing device 650.

The mobile computing device 650 may also communicate audibly using an audio codec 660, which may receive spoken information from a user and convert it to usable digital information. The audio codec 660 may likewise generate audible sound for a user, such as through a speaker, e.g., in a handset of the mobile computing device 650. Such sound may include sound from voice telephone calls, may include recorded sound (e.g., voice messages, music files, etc.) and may also include sound generated by applications operating on the mobile computing device 650.

The mobile computing device 650 may be implemented in a number of different forms, as shown in the figure. For example, it may be implemented as a cellular telephone 680. It may also be implemented as part of a smart-phone 682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

In view of the structure, functions and apparatus of the systems and methods described here, in some implementations, a system and method for providing ETFs for retirement accounts plans are provided. Having described certain implementations of methods and apparatus for supporting ETFs for retirement accounts plans, it will now become apparent to one of skill in the art that other implementations incorporating the concepts of the disclosure may be used. Therefore, the disclosure should not be limited to certain implementations, but rather should be limited only by the spirit and scope of the following claims.

Throughout the description, where apparatus and systems are described as having, including, or comprising specific components, or where processes and methods are described as having, including, or comprising specific steps, it is contemplated that, additionally, there are apparatus, and systems of the disclosed technology that consist essentially of, or consist of, the recited components, and that there are processes and methods according to the disclosed technology that consist essentially of, or consist of, the recited processing steps.

It should be understood that the order of steps or order for performing certain action is immaterial so long as the disclosed technology remains operable. Moreover, two or more steps or actions may be conducted simultaneously.

What is claimed:

1. A method comprising:
receiving, by a processor of a computing device, for each of a plurality of retirement plan accounts, a request to purchase shares of an exchange traded fund (ETF), wherein:
each retirement plan account of the plurality of retirement plan accounts is associated with one of a plurality of retirement plans serviced by an entity,
each of the plurality of requests are made during a specified time period, and
each of the plurality of requests identify an amount of money or a number of shares to invest in the ETF;
determining, by the processor, a sum of money to invest in the ETF based at least in part on the plurality of requests;
determining, by the processor, a first number of shares of the ETF to purchase for the plurality of retirement plan accounts to satisfy the plurality of requests based at least in part on the sum of money and a market price, wherein the first number of shares is not a whole number;
determining, by the processor, a total whole number of shares of the ETF to purchase by rounding the first number of shares up to a nearest whole number of shares, wherein a house account associated with the entity is used to provide funds so that a whole number of shares is purchased with the sum of money and funds from the house account, thereby allowing at least one of the retirement plan accounts to be allocated a fractional share; and
sending, by the processor, an order to purchase the total whole number of shares of the ETF.

2. The method of claim 1, wherein the entity funds the house account.

3. The method of claim 1, wherein the sum of money to invest in the ETF is the sum of money the plurality of requests identified to be invested in the ETF during the specified time period.

4. The method of claim 1, wherein determining the sum of money to invest in the ETF comprises:
aggregating, by the processor, the amount of money to invest in the ETF for each of the plurality of retirement plans; and
aggregating, by the processor, the amount of money to invest in the ETF for all of the plurality of retirement plans.

5. The method of claim 1, wherein the market price is determined based on a third party price feed at a time before an end of the specified time period.

6. The method of claim 1, wherein the specified time period is a time period selected from the group consisting of: 9:30 a.m.-10:00 a.m. ET; 10:00 a.m.-11:00 a.m. ET; 11:00 a.m.-12:00 p.m. ET; 12:00 p.m.-1:00 p.m. ET; 1:00 p.m.-2:00 p.m. ET; 2:00 p.m.-3:00 p.m. ET; and 3:00 p.m.-3:30 p.m. ET.

7. The method of claim 1, wherein the specified time period is one of a plurality of time periods during market hours.

8. A method comprising:
receiving, by a processor of a computing device, for each of a plurality of retirement plan accounts, a request to sell shares of an exchange traded fund (ETF), wherein:
each retirement plan account of the plurality of retirement plan accounts is associated with one of a plurality of retirement plans serviced by an entity,
each of the plurality of requests are made during a specified time period, and
each of the plurality of requests identify at least one of an amount of money, a percentage of a holding, and a number of shares to sell of the ETF;
determining, by the processor, a sum of money to sell of the ETF based at least in part on the plurality of requests;
determining, by the processor, a first number of shares of the ETF to sell for the plurality of retirement plan accounts to satisfy the plurality of requests based at least in part on the sum of money and a market price, wherein the first number of shares is not a whole number;
determining, by the processor, a total whole number of shares of the ETF to sell by rounding the first number of shares up to a nearest whole number of shares, wherein a house account associated with the entity is used to provide a fractional ETF share such that a whole number of shares is sold with the sum of money and shares from the house account, thereby allowing at least one of the retirement plan accounts to transact in fractional shares; and
sending, by the processor, an order to sell the total whole number of shares of the ETF.

9. The method of claim 8, wherein the entity funds the house account.

10. The method of claim 8, wherein the sum of money to sell of the ETF is the sum of money the plurality of requests identified to be sold of the ETF shares during the specified time period.

11. The method of claim 8, wherein determining the sum of money to sell of the ETF shares comprises:
aggregating, by the processor, the amount of money to sell of the ETF for each of the plurality of retirement plans; and
aggregating, by the processor, the amount of money to sell of the ETF for all of the plurality of retirement plans.

12. The method of claim 8, wherein the market price is determined based on a third party price feed at a time before an end of the specified time period.

13. The method of claim 8, wherein the specified time period a time period selected from the group consisting of: 9:30 a.m.-10:00 a.m. ET; 10:00 a.m.-11:00 a.m. ET; 11:00 a.m.-12:00 p.m. ET; 12:00 p.m.-1:00 p.m. ET; 1:00 p.m.-2:00 p.m. ET; 2:00 p.m.-3:00 p.m. ET; and 3:00 p.m.-3:30 p.m. ET.

14. The method of claim 8, wherein the specified time period is one of a plurality of time periods during market hours.
